(19) United States
(12) Patent Application Publication
(10) Pub. No.: US 2025/0058566 A1
(43) Pub. Date: Feb. 20, 2025

(54) THERMAL PRINT HEAD AND METHOD FOR MANUFACTURING THEREOF

(71) Applicant: ROHM CO., LTD., KYOTO-SHI (JP)

(72) Inventor: GORO NAKATANI, KYOTO-SHI (JP)

(21) Appl. No.: 18/794,603

(22) Filed: Aug. 5, 2024

(30) Foreign Application Priority Data
Aug. 18, 2023 (JP) 2023-133467

(51) Int. Cl. B41J 2/335

(52) U.S. Cl. CPC B41J 2/3354; B41J 2/3353; B41J 2/33545; B41J 2/3359; B41J 2202/31

(57) ABSTRACT

The present disclosure provides a thermal print head. The thermal print head includes: a substrate; a glaze layer; a wiring layer; a heat element; and a protective layer. The glaze layer is disposed on the substrate. The wiring layer is disposed on the glaze layer. The wiring layer has a common electrode and a plurality of individual electrodes. The common electrode has protrusions arranged in intervals along a first direction in a plan view and extending along a second direction perpendicular to the first direction in the plan view. The plurality of individual electrodes have tip portions extending along the second direction. The protrusions and the tip portions are alternately arranged in intervals along the first direction in the plan view. The heat element extends along the first direction in the plan view, is disposed on the glaze layer, and overlaps with the protrusions and the tip portions.

### TECHNICAL FIELD

The present disclosure relates to a thermal print head and a method for manufacturing a thermal print head.

### BACKGROUND

For example, the Japanese Patent Publication No. 2023-077118 (patent publication 1) discloses a thermal print head. The thermal print head disclosed in patent document 1 includes a substrate, a glaze layer, a wiring layer, a heat element and a protective layer.

The glaze layer is disposed on the substrate. The wiring layer is disposed on the glaze layer. The wiring layer includes a common electrode and multiple individual electrodes. The common electrode includes multiple protrusions. These protrusions are arranged at intervals in a first direction in a plan view, and extend in a second direction perpendicular to the first direction. The individual electrodes have tip portions extending in the second direction in the plan view. The protrusions and the tip portions are alternately arranged at intervals along the first direction in the plan view. The heat element disposed on the glaze layer while overlapping the protrusions and the tip portions. The heat element extends in the first direction in the plan view. The protective layer is disposed on the glaze layer to cover the wiring layer and the heat element.

### PRIOR ART DOCUMENT

### Patent Publication

[Patent document 1] Japan Patent Publication No. 2023-077118

### BRIEF DESCRIPTION OF THE DRAWINGS

FIG. 1 is a plan view of a thermal print head 100.

FIG. 2 is a cross-sectional view along a line II-II in FIG. 1.

FIG. 3 is a cross-sectional view along a line III-III in FIG. 1.

FIG. 4 is a diagram of steps for manufacturing the thermal print head 100.

FIG. 5 is a cross-sectional view of glaze layer forming step S2.

FIG. 6 is a cross-sectional view of wiring layer forming step S3.

FIG. 7 is a cross-sectional view of heat element forming step S5.

FIG. 8 is a cross-sectional view of first step S71.

FIG. 9 is a cross-sectional view of second step S72.

FIG. 10 is a cross-sectional view of a thermal print head 100A.

FIG. 11 is a plan view of a thermal print head 100B.

FIG. 12 is a cross-sectional view along a line XII-XII in FIG. 11.

### DETAILED DESCRIPTION OF THE EMBODIMENTS

### Detailed Description

Details the present disclosure are described with the accompanying drawings below. The same or equivalent parts are denoted by the same numerals or symbols in the accompanying drawings below, and the repeated description is omitted. A thermal print head 100 is used as a thermal print head of the embodiment.

### (Configuration of Thermal Print Head 100)

The configuration of the thermal print head 100 is described below.

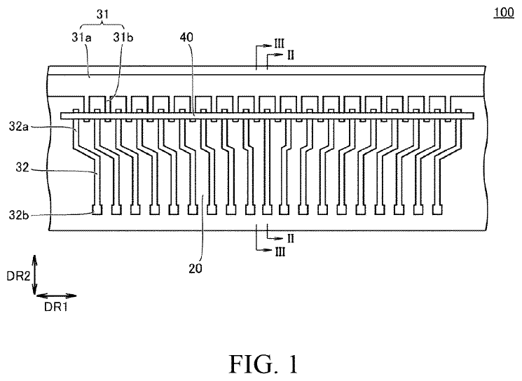

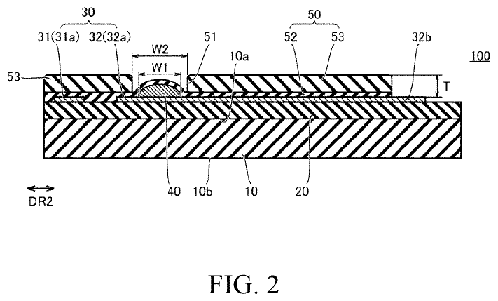

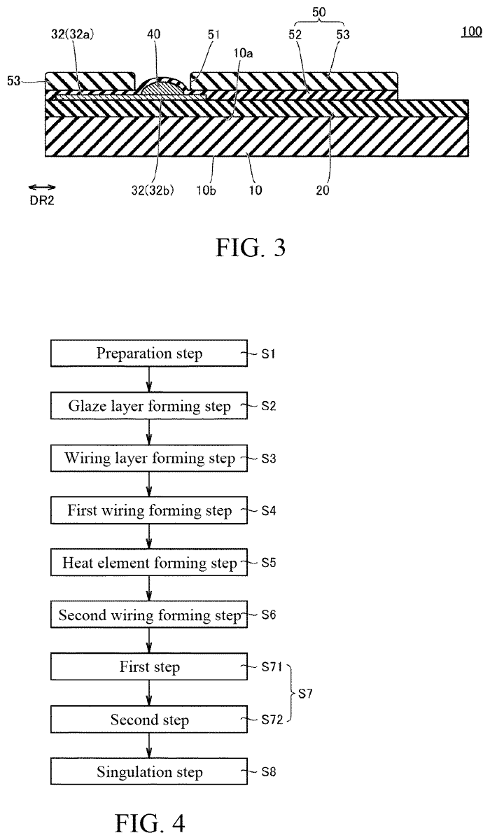

FIG. 1 shows a plan view of a thermal print head 100. In FIG. 1, the drawing of a protective layer 50 is omitted. FIG. 2 shows a cross-sectional view along the line II-II in FIG. 1. FIG. 3 shows a cross-sectional view along the line III-III in FIG. 1. As shown in FIG. 1 to FIG. 3, the thermal print head 100 includes a substrate 10, a glaze layer 20, a wiring layer 30, a heat element 40 and a protective layer 50.

The substrate 10 includes a main surface 10a and a main surface 10b. The main surface 10a and the main surface 10b are end surfaces of the substrate 10 in a thickness direction. The main surface 10b is a surface opposite to the main surface 10a. A main component of a constituting material of the substrate 10 is, for example, ceramic such as aluminum oxide (Al₂O₃). The main component refers to a component accounting for more than 50% by weight in the constituting material.

The glaze layer 20 is disposed on the substrate 10. More specifically, the glaze layer 20 is disposed on the main surface 10a. A main component of a constituting material of the glaze layer 20 is a glass.

The wiring layer 30 is disposed on the glaze layer 20. The wiring layer 30 includes a common electrode 31 and multiple individual electrodes 32. A main component of a constituting material of the wiring layer 30 is, for example, gold (Au).

The common electrode 31 includes a strip portion 31a and multiple protrusions 31b. The strip portion 31a extends in a first direction DR1 in a plan view. The term “plan view” refers to a situation of viewing from the side of the main surface 10a along a normal direction of the main surface 10a. The multiple protrusions 31b are arranged at intervals in the first direction DR1 in the plan view. The protrusions 31b extend in a second direction DR2 in the plan view. The second direction D2 is a direction perpendicular to the first direction DR1 in the plan view. The protrusions 31b protrude from one side of the strip portion 31a extending in the first direction DR1.

The multiple individual electrodes 32 are arranged in the first direction DR1 in the plan view. Each of the individual electrodes 32 includes a tip portion 32a on one end. The tip portion 32a extends in the second direction DR2 in the plan view. The tip portions 32a and the protrusions 31b are alternately arranged at intervals in the first direction DR1 in the plan view. Each of the individual electrodes 32 includes a bonding pad 32b on the other end.

Although not shown in the drawings, the thermal print head 100 further includes a first wiring and a second wiring. The first wiring is disposed on the glaze layer 20 so as to be connected to the common electrode 31 (the strip portion 31a). The second wiring is disposed on the first wiring. A main component of a constituting material of the first wiring and the second wiring is, for example, silver (Ag). The first wiring and the second wiring are formed by, for example, sintered bodies containing multiple silver particles.

The heat element 40 extends in the first direction DR1 in the plan view. The heat element 40 is disposed on the glaze layer 20 while overlapping the protrusions 31b and the tip portions 32a. That is to say, the adjacent protrusion portion 31b and tip portion 32a are electrically connected by the heat element 40. The heat element 40 is formed by, for example, sintered bodies containing ruthenium oxide (RuO₂) particles.

The protective layer 50 is disposed on the glaze layer 20 to cover the wiring layer 30, the heat element 40, the first wiring and the second wiring. Moreover, the bonding pad 32b is exposed from the protective layer 50. A main component of a constituting material of the protective layer 50 is a glass.

A recesses 51 is formed on a surface of the protective layer 50. The recess 51 extends in the first direction DR1 in the plan view. The recess 51 overlaps the heat element 40 in the plan view. A width of the heat element 40 in the second direction DR2 is set as a width W1. A width of the recess 51 in the second direction DR2 is set as a width W2. The width W2 is preferably within a range of ±50 μm with respect to the width W1. That is to say, an absolute value of a difference between the width W2 and the width W1 is preferably less than or equal to 50 μm. Preferably, in a cross section perpendicular to the first direction DR1, a bottom surface of the recess 51 becomes a curve shape that is convex upward. The term “convex upward” refers to being convex toward the side opposite to the substrate 10.

The protective layer 50 includes, for example, a first layer 52 and a second layer 53. The first layer 52 covers the wiring layer 30 and the heat element 40. The second layer 53 covers the first layer 52 while avoiding above the heat element 40. The bottom surface of the recess 51 is formed by a surface of the first layer 52 exposed from the second layer 53. A thickness of the second layer 53 is set as a thickness T. Attaching of paper becomes less likely to occur as the thickness T increases. On the other hand, printing on paper thins if the thickness T is overly large. To attend to the aspects above, the thickness T is preferably equal to or less than 10 μm. Moreover, a thickness of the first layer 52 can also be equal to or less than a thickness of the protective layer 50 in the configuration shown in FIG. 10. In addition, a height of the heat element 40 is equal to a height of the heat element 40 in the configuration shown in FIG. 10.

The bonding pad 32b is electrically connected to a driving integrated circuit (IC) by a bonding wire (not shown). The driving IC selectively supplies a voltage to the individual electrode 32 via the bonding wire. On the other hand, a common voltage is supplied to the common electrode 31 via the first wiring and the second wiring. The part of the heat element 40 connected between the tip portion 32a of one individual electrode 32 selectively supplied with the voltage and the protrusion 31b adjacent to the tip portion 32a of the one individual electrode 32 is energized and generates heat. The heat is transferred to paper in contact with the protective layer 50 covering the surface of the heat element 40, and printing is performed on the paper.

### <Variation Example>

The first layer 52 can also be formed to cover the wiring layer 30 without covering the heat element 40 (covering the wiring layer 30 while avoiding the heat element 40). The second layer 53 can also be formed to cover the first layer 52 and the heat element 40.

### (Method for Manufacturing Thermal Print Head 100)

Next, a method for manufacturing the thermal print head 100 is described below.

FIG. 4 shows a diagram of steps for manufacturing the thermal print head 100. As shown in FIG. 4, the method for manufacturing the thermal print head 100 includes preparation step S1, glaze layer forming step S2, wiring layer forming step S3, first wiring forming step S4, heat element forming step S5, second wiring forming step S6, protective layer forming step S7 and singulation step S8.

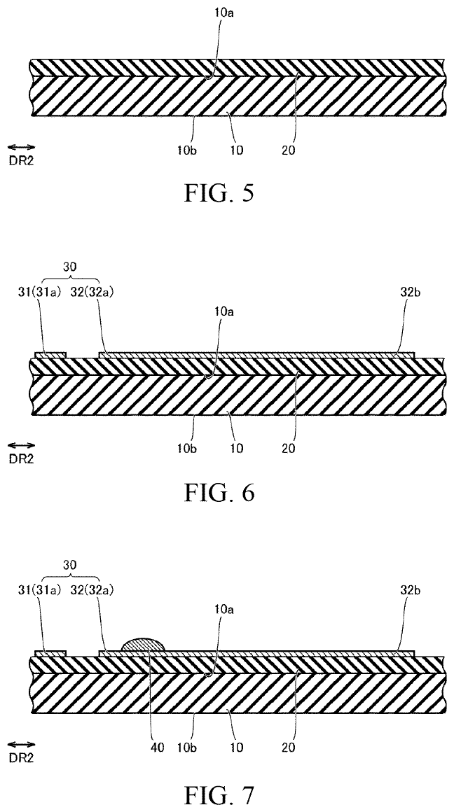

In the preparation step S1, the substrate 10 is prepared. The glaze layer forming step S1 is performed after the preparation step S1. FIG. 5 shows a cross-sectional view of the glaze layer forming step S2. As shown in FIG. 5, in the glaze layer forming step S2, the glaze layer 20 is formed by applying a slurry containing glass on the main surface 10a and then firing the applied slurry. The wiring layer forming step S3 is performed after the glaze layer forming step S2.

FIG. 6 shows a cross-sectional view of the wiring layer forming step S3. As shown in FIG. 6, the wiring layer 30 is formed in the wiring layer forming step S3. In the wiring layer forming step S3, first of all, a resinate slurry containing the constituent material of the wiring layer 30 is applied on the glaze layer 20. Secondly, a metal layer is formed by firing the applied resinate slurry. Thirdly, a resist pattern is formed on the metal layer. The resist pattern is formed by applying a photoresist on the metal layer, and exposing and developing the applied photoresist. Fourthly, the metal layer is etched by using the resist pattern as a mask. Accordingly, the metal layer 33 patterned and becomes the wiring layer 30. The first wiring forming step S4 is performed after the wiring layer forming step S3.

The first wiring is formed in the first wiring forming step S4. The first wiring is formed by applying a conductive slurry containing multiple silver particles, and firing the applied conductive slurry. The heat element forming step S5 is performed after the first wiring forming step S4.

FIG. 7 shows a cross-sectional view of the heat element forming step S5. As shown in FIG. 7, in the heat element forming step S5, first of all, a slurry containing (RuO₂) particles is applied on the glaze layer 20. The slurry is applied along the first direction DR1 while overlapping the protrusions 31b and the tip portions 32a in the plan view. Secondly, the heat element 40 is formed by firing the applied slurry. The second wiring forming step S6 is performed after the first wiring forming step S5.

The second wiring is formed in the second wiring forming step S6. The second wiring is formed by applying a conductive slurry containing multiple silver particles, and firing the applied conductive slurry. The protective layer forming step S7 is performed after the second wiring forming step S6.

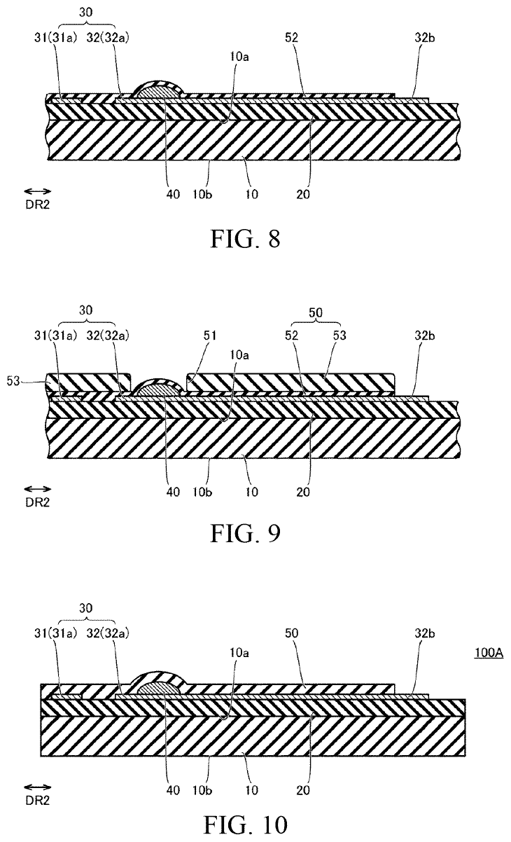

The protective layer forming step S7 includes first step S71 and second step S72. The second step S72 is performed after the first step S71. FIG. 8 shows a cross-sectional view of the first step S71. As shown in FIG. 8, in the first step S71, the first layer 52 is formed to cover the wiring layer 30, the heat element 40, the first wiring and the second wiring. In the first step S71, first of all, a slurring containing glass is applied. Secondly, the applied slurry is fired. Accordingly, the first layer 52 is formed.

FIG. 9 shows a cross-sectional view of the second step S72. As shown in FIG. 9, in the second step S72, the second layer 53 is formed to cover the first layer 52. In the second step S72, first of all, a slurring containing glass is applied on the first layer 52. At this point, the slurry is applied while avoiding above the heat element 40. Secondly, the applied slurry is fired. Accordingly, the second layer 53 is formed on the first layer 52 while avoiding above the heat element 40. Moreover, since the second layer 53 is not formed above the heat element 40, the recess 51 is formed on the protective layer 50 while overlapping the heat element 40 in the plan view. The singulation step S8 is performed after the protective layer forming step S7 (the second step S72).

In the singulation step S8, the substrate 10, the glaze layer 20 and the protective layer 50 are cut according a position that is to become an outer periphery of the thermal print head 100. With the above steps, the thermal print head 100 having the structure shown in FIG. 1 to FIG. 3 is formed.

### <Variation Example>

In the first step S71, the first layer 52 can also be formed to over the wiring layer 30 without covering the heat element 40. In this case, in the second step S72, the second layer 53 can be formed to cover the first layer 52 and the heat element 40. With the approach above, the protective layer 50 having the recess 51 can also be formed on a surface.

### (Effects of Thermal Print Head 100)

The effects of the thermal print head 100 are described below by means of comparison with a comparison example below. A thermal print head of comparison example 1 is set as a thermal print head 100A, and a thermal print head of comparison example 2 is set as a thermal print heat 100B.

FIG. 10 shows a cross-sectional view of the thermal print head 100A. As shown in FIG. 10, the thermal print head 100A includes the substrate 10, the glaze layer 20, the wiring layer 30, the heat element 40 and the protective layer 50. In the thermal print head 100A, the recess 51 is not formed on the surface of the protective layer 50 while overlapping the heat element 40.

Due to the lack of the recess 51 in the thermal print head 100A, a contact area between paper as a printing target and the surface of the protective layer 50 can be increased easily. As a result, it is possible that attaching occurs at the thermal print head 100A (an occurrence of attachment of paper on the surface of the protective layer 50). On the other hand, with the presence of the recess 51 in the thermal print head 100, a contact area between paper as a printing target and the surface of the protective layer 50 is unlikely to be increased. Thus, according to the thermal print head 100, attachment of paper on the surface of the protective layer 50 can be suppressed.

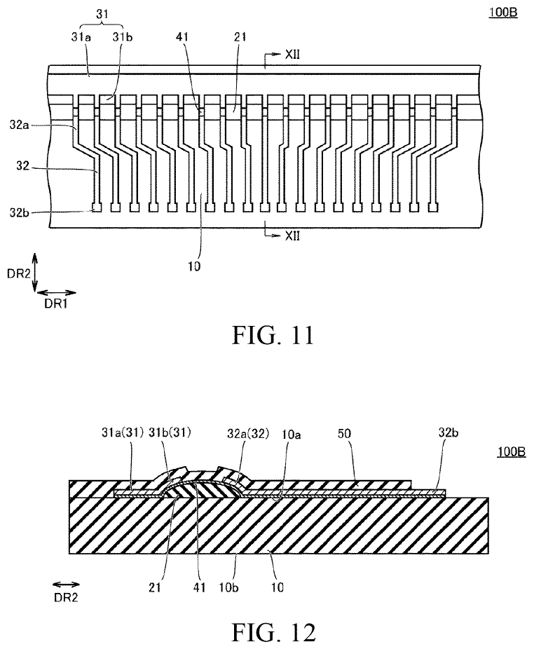

FIG. 11 shows a plan view of a thermal print head 100B. FIG. 12 shows a cross-sectional view along the line XII-XII in FIG. 11. As shown in FIG. 11 to FIG. 12, the thermal print head 100B includes the substrate 10, a glaze layer 21, the wiring layer 30 (the common electrode 31 and the multiple individual electrodes 32), a heat element 41 and the protective layer 50.

The glaze layer 21 is disposed on the main surface 10a to extend in the first direction DR1. In the thermal print head 100B, the wiring layer 30, except for a protrusion 31b and a tip portion 32a, is disposed on the main surface 10a. The protrusion 31b and the tip portion 32a extend in the second direction DR2 in the plan view so as to reach above the glaze layer 21. That is to say, the protrusion 31b and the tip portion 32a are alternately arranged in the first direction DR2. The heat element 41 is arranged between the substrate 10 or the glaze layer 21 and the wiring layer 30. Since the protrusion 31b and the tip portion 32a are opposite to each other at an interval, the heat element 41 is exposed from between the protrusion 31b and the tip portion 32a.

The protective layer 50 covers the glaze layer 21, the wiring layer 30, and the heat element 41 exposed from between the protrusion 31b and the tip portion 32a. The part between the protrusion 31b and the tip portion 32a contains a step difference because the wiring layer 30 in between is removed. The step difference also causes a step difference to be formed on the surface of the protective layer 50. Thus, in the thermal print head 100B, a contact area between paper as a printing target and the surface of the protective layer 50 is unlikely to be increased, thereby suppressing paper from being attached on the surface of the protective layer 50. However, in the thermal print head 100B, since the heat element 41 exposed from between the protrusion 31b and the tip portion 32a generates heat in a uniform manner, in combination with the aspect that the contact area between paper as a printing target and the surface of the protective layer 50 is unlikely to be increased, print efficiency is degraded.

On the other hand, in the thermal print head 100, as a current flows in a centralized manner through a central portion of the heat element 40 in the second direction DR2, the heat element 40 generates heat in a centralized manner at the central portion in the second direction DR2. Thus, even if the contact area between paper and the surface of the protective layer 50 cannot be easily increased due to the recess 51 formed, printing efficiency can be maintained.

If the width W2 is overly small with respect to the width W1, it is then difficult for paper as a printing target to come into contact with the surface of the protective layer 50 (that is to say, the bottom surfaces of the recesses 51) covering the heat element 40, and printing can be obstructed. On the other hand, if the width W2 is overly large with respect to the width W1, the effect of suppressing an increase in the contact area between paper and the surface of the protective layer 50 can become inadequate. Thus, when the width W2 is within a range of greater than or equal to ±50 μm of the width W1, printing can be more properly performed while suppressing attachment of paper. When the bottom surface of the recess 51 in a cross section in the first direction DR1 is in a curve shape that is convex upward, an increase in the contact area between paper and the surface of the protective layer 50 can be more easily suppressed.

1. A thermal print head, comprising:
a substrate;
a glaze layer;
a wiring layer;
a heat element; and
a protective layer, wherein
the glaze layer is disposed on the substrate,
the wiring layer is disposed on the glaze layer,
the wiring layer has a common electrode and a plurality of individual electrodes,
the common electrode has protrusions arranged in intervals along a first direction in a plan view and extending along a second direction perpendicular to the first direction in the plan view,
the plurality of individual electrodes have tip portions extending along the second direction,
the protrusions and the tip portions are alternately arranged in intervals along the first direction in the plan view,
the heat element extends along the first direction in the plan view, is disposed on the glaze layer, and overlaps with the protrusions and the tip portions,
the protective layer is disposed on the glaze layer to cover the wiring layer and the heat element,
a recess is formed on a surface of the protective layer, and
the recess extends along the first direction in a manner of overlapping with the heat element in the plan view.

2. The thermal print head of claim 1, wherein a width of the recess along the second direction is within a range of about ±50 μm with respect to a width of the heat element along the second direction.

3. The thermal print head of claim 1, wherein a bottom surface of the recess has an upwardly convex curved shape in a cross-sectional view perpendicular to the first direction.

4. The thermal print head of claim 2, wherein a bottom surface of the recess has an upwardly convex curved shape in a cross-sectional view perpendicular to the first direction.

5. A method of manufacturing a thermal print head, comprising:
providing a substrate;
forming a glaze layer on the substrate;
forming a wiring layer on the glaze layer;
forming a heat element on the glaze layer; and
forming a protective layer on the glaze layer to cover the wiring layer and the heat element, wherein
the wiring layer has a common electrode and a plurality of individual electrodes,
the common electrode has protrusions arranged in intervals along a first direction in a plan view and extending along a second direction perpendicular to the first direction in the plan view,
the plurality of individual electrodes have tip portions extending along the second direction,
the protrusions and the tip portions are alternately arranged in intervals along the first direction in the plan view,
the heat element extends along the first direction in the plan view and is disposed on the glaze layer while overlapping with the protrusions and the tip portions,
the protective layer is disposed on the glaze layer to cover the wiring layer and the heat element,
a recess is formed on a surface of the protective layer, and
the recess extends along the first direction in a manner of overlapping with the heat element in the plan view.

6. The method of claim 5, wherein
the protective layer includes a first layer and a second layer,
in the forming of the protective layer, the second layer is formed after the first layer is formed,
the first layer covers the wiring layer and the heat element, and
the second layer covers the first layer and uncovers an area above the heat element.

7. The method of claim 5, wherein
the protective layer includes a first layer and a second layer,
in the forming of the protective layer, the second layer is formed after the first layer is formed,
the first layer covers the wiring layer, and
the second layer covers the heat element and the first layer.
